(19) United States
(12) Patent Application Publication
(10) Pub. No.: US 2010/0065201 A1
(43) Pub. Date: Mar. 18, 2010

(54) Label and Method of Labeling Wine Bottles

(76) Inventor: Gary Means, Edinboro, PA (US)

Correspondence Address: Joseph F. Gula, III, 120 West Tenth Street, Erie, PA, 16501, US

(21) Appl. No.: 12/210,281

(22) Filed: Sep. 15, 2008

(51) Int. Cl. G09F 3/02; B65C 1/02; G09F 3/10; G09F 3/00

(52) U.S. Cl. 156/277; 40/311; 283/70

(57) ABSTRACT

A round label having three distinct areas for indicia relating to the contents of a wine bottle and a method of using the same. The label can have pre-printed indicia relating to the variety of wine and spaces upon which a person can indicate by hand-writing the winery and the vintage year for the wine. Once the label contains the appropriate indicia, it is removed from its backing and then affixed to the top of the wine bottle using the adhesive located on the back of the label. The wine bottle can then be placed into its holding bin, such as a wine rack or wine cooler, with the newly affixed label easily identifying the contents while the original vintner's label is obscured by the holding bin.

### CROSS-REFERENCE TO RELATED APPLICATIONS

Not Applicable

### FEDERALLY SPONSORED RESEARCH

Not Applicable

### BACKGROUND

This invention relates to a label and method of labeling wine bottles.

### SUMMARY

Wine aficionados and casual wine drinkers alike frequently keep more than one bottle and type of wine at a time. Most people will place wine bottles into a wine rack or wine cooler or other suitable wine storage unit to utilize the wine at a later time. However, when a wine bottle is tilted on its side, as when it is stored in most wine racks and wine coolers, a person is unable to ascertain the name of the wine or even the type of wine because a wine bottle comes from the vintner labeled on its side. Thus, the present invention is directed to a label and method of labeling wine bottles when they are in their side position and their original vintner labels are obscured, such as when stored in a wine rack or wine cooler as disclosed herein.

### BRIEF DESCRIPTION OF THE DRAWINGS

These and other features, aspects and advantages of the present invention will become better understood with regard to the following description, appended claims, and accompanying drawings where:

FIG. 1 illustrates a perspective view of the wine bottle label with pre-printed “Merlot” indicating the type of wine and hand-written terms “Allegrini” and “2004” for the corresponding name of the winery and vintage year.

FIG. 2 illustrates a perspective view of the wine bottle label with only a pre-printed term “Merlot” and two spaces in which to hand-write the name of the winery and the vintage year.

FIG. 3 illustrates a perspective view of the wine bottle label with empty spaces in which the user is to hand-write the variety of wine, the name of the winery and the vintage year.

FIG. 4 illustrates a side elevation view of a horizontally positioned wine bottle with the wine bottle label affixed to the top.

FIG. 5 illustrates a side elevation view of a wine storage unit with wine bottles located inside with their tops exposed, three wine bottles have the wine bottle label affixed to the top and the other three wine bottles have no label so affixed.

### DESCRIPTION

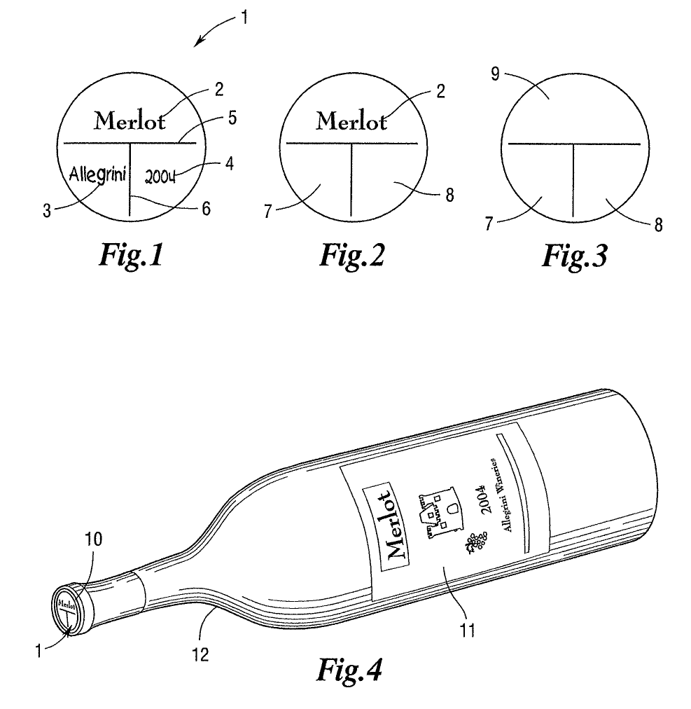

As shown in FIG. 1, a round label 1 with a horizontal dividing line 5, a vertical dividing line 6, a pre-printed term describing the variety of wine 2, a handwritten term describing the winery 3 and a hand-written term describing the vintage year 4.

FIG. 2. illustrates the round label 1 with said pre-printed variety 2 above said horizontal line 5, and empty space 7 to the left of said vertical line 6 and an empty space 8 to the right of said vertical line 6.

FIG. 3 illustrates said round label 1 with an empty space 9 above the vertical line 5, an empty space 7 to the left of said vertical line 6 and an empty space 8 to the right of said vertical line 6.

FIG. 4 illustrates said round label 1 affixed to the top of a wine bottle 12 while said bottle is in a horizontal position and the vintner's original label 11 is ascertainable.

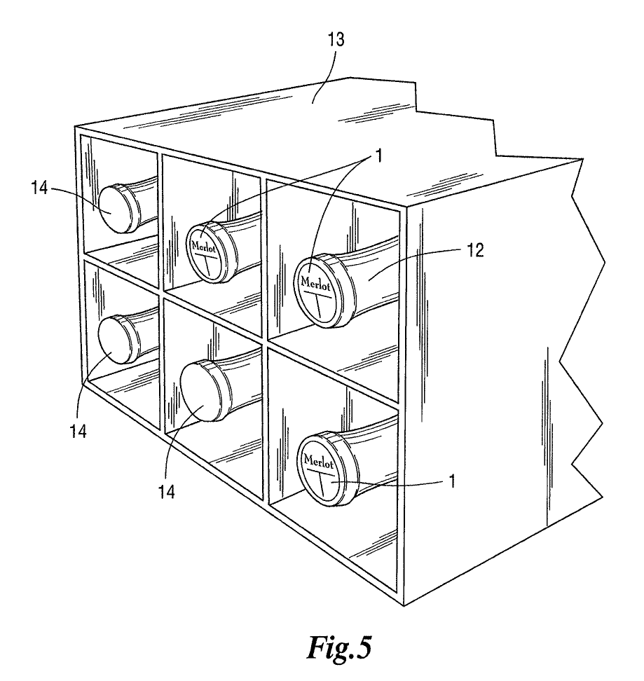

FIG. 5 illustrates a plurality of wine bottles 12 arranged in a wine rack 13 with three of the wine bottles having said label 1 affixed to the top and three other wine bottles having no label 14 affixed to the top.

Said label 1 can be manufactured from either a paper-like material or a foil-type material and has an adhesive layer on its reverse side.

The manner of use of the wine label is to utilize a label 1 with an adhesive on the reverse side affixed to a wax-type backing paper, said label having a pre-printed variety of wine 2, hand-writing with a pen, pencil or other suitable means to indicate the name of the winery in the empty space 7 and the vintage year in the empty space 8 on the front side as in FIG. 1. The pre-printed varieties of wine comprises the list of Merlot, Chardonnay, Cabernet Sauvignon and Pinot Grigio. Once the label 1 has the appropriate indicia, it is removed from said backing paper and affixed to the top 10 of a wine bottle 12 as in FIG. 4. The entire wine bottle 12 is then placed in a wine storage unit 13 with said wine label 1 facing out so that the contents of the wine bottle can be easily ascertained due to the obscuring of the original vintner label 11 in said storage unit 13 as in FIG. 5.

An alternative label, as in FIG. 3, does not have a pre-printed variety of wine 2, but instead has an empty space 9 which the user can then indicate the variety of wine.

From the description above, a number of advantages of the method for labeling wine bottles become evident:

(a) Easy identification of the contents of a bottle of wine when the bottle of wine is located in a storage unit such as a wine rack or wine cooler;
(b) Fast identification of the contents of a bottle of wine when the bottle of wine is located in a storage unit such as a wine rack or wine cooler;
(c) Inexpensive means for identification of the contents of a bottle of wine when the bottle of wine is located in a storage unit such as a wine rack or wine cooler; and,
(d) Flexible way to identify the contents of a bottle of any type of wine when the bottle of wine is located in a storage unit such as a wine rack or wine cooler.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specific function, or “step for” performing a specific function, is not to be interpreted as a “means” or “step” clause as specified in 35 U.S.C.§112 para. 6. In particular, the use of “step of” in the claims herein is not intended to invoke the provisions of 35 U.S.C.§112 para. 6.

I claim:

1. A wine bottle label comprising:
a label comprised of a paper-like or foil-type material having a front side and a reverse side;
the reverse side comprises an adhesive layer;
the front side comprises three areas for placing indicia relating to the variety of wine, the name of the wine and the vintage year; and,
said label is affixed to a wax-paper backing material.

2. The label of claim 1, whereby the variety of wine is pre-printed on said front side.

3. The label of claim 1, whereby the label is round.

4. The label of claim 2, whereby the label is round.

5. The label of claim 3, whereby the label is approximately one inch in diameter.

6. The label of claim 4, whereby the label is approximately one inch in diameter.

7. A method for labeling an unopened wine bottle comprising:
placing a bottle of wine so that the cork side is on the top;
obtaining a label having three areas for indicating the variety of wine, the name of the winery and the vintage year and said label affixed to a wax-paper backing;
writing on said label the variety of wine, the name of the winery and the vintage year with a writing utensil;
removing said label from the wax-paper backing;
affixing said label on the top of said bottle; and,
placing the labeled bottle of wine in a horizontal position with said label facing the ultimate user so that the contents can be identified.

8. The method of claim 7 wherein the label has a pre-printed variety of wine.

9. The method of claim 7 including the step of placing the labeled bottle cork side on top and vertically in a box with the label on the top so that the contents can be identified.

10. The method of claim 8 including the step of placing the labeled bottle cork side on top and vertically in a box with the label on the top so that the contents can be identified.
